(19) United States
(12) Patent Application Publication
(10) Pub. No.: US 2007/0006951 A1
(43) Pub. Date: Jan. 11, 2007

(54) VENTILATED TIRES

(76) Inventor: Wade Summers, Louisville, KY (US)

Correspondence Address: CAMORIANO & ASSOCIATES, 8225 SHELBYVILLE ROAD, LOUISVILLE, KY, 40222, US

(21) Appl. No.: 11/160,745

(22) Filed: Jul. 7, 2005

(51) Int. Cl. B60C 23/18

(52) U.S. Cl. 152/153

(57) ABSTRACT

Tires define air flow passageways arranged so that rotation of the tire causes air to flow through the passageways, thereby improving heat transfer to cool the tires.

### BACKGROUND

As a tire rotates, the tire tread rubber is compressed by the weight of the vehicle and then uncompressed by further rotation. This momentary loss of shape and size generates heat within the tread rubber. “Hysteresis” is the scientific term that is used to describe this generation of heat as the rubber repeatedly deforms and recovers its shape. At typical vehicle weights and speeds, the normal heat transfer mechanisms of conduction, convection and radiation are generally able to transfer heat out of the tread area sufficiently. However, at high rotational speeds (causing a high frequency of compression) or at heavy vehicular loads, the hysteretic heat gain is much greater, and the temperature of the tire can reach a point where the rubber degrades.

Hysteretic heat gain has been a well known concern of tire and rubber companies since the beginnings of the use of rubber in tires. The majority of the work to overcome the limitations of heat generation has been directed at chemically modifying the rubber composition to prevent hysteresis loss.

### BRIEF SUMMARY

The embodiments that are shown and described herein are examples of wheels equipped with air passageways to ventilate and cool the tire tread. The rotation of the wheel drives air through the passageways to provide a continual passage of air through the tire. In one embodiment, the air passageway extends through the rim and the tire, and the air flow is driven by the centrifugal force of the rotating tire, with the air flowing into the tire interior through the rim and then out through the tire. In another embodiment, designed for knobby tires, the air passageways extend through the base of the tire knobs in the direction of rotation of the tire.

### BRIEF DESCRIPTION OF THE DRAWINGS

FIG. 1 is a schematic side sectional view of a wheel assembly made in accordance with the present invention;

FIG. 2 is a view taken along line a-a of FIG. 1;

FIG. 3 is a schematic side sectional view of another embodiment of a wheel assembly made in accordance with the present invention; and

FIG. 4 is a view taken along line b-b of FIG. 3.

### DETAILED DESCRIPTION

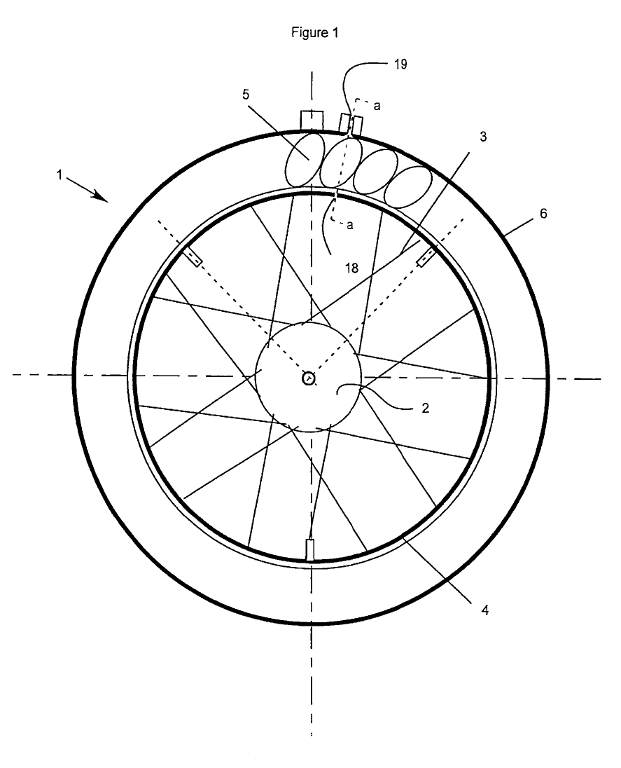

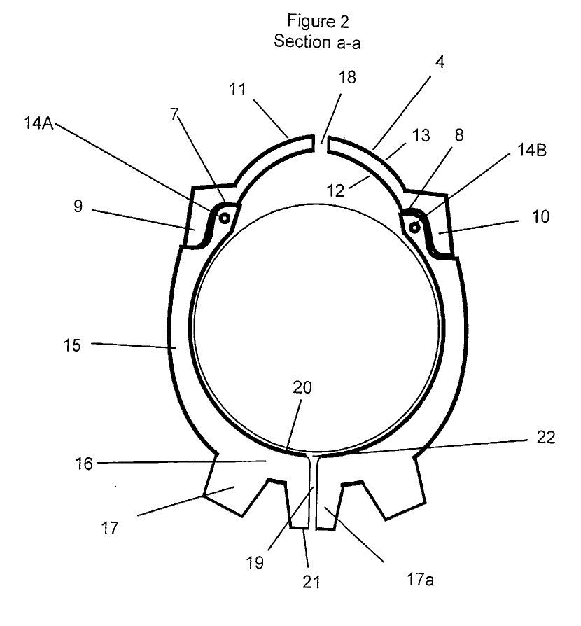

FIGS. 1 and 2 show one embodiment of a ventilated tire assembly made in accordance with the present invention. In this embodiment, the tires use internal balls, which provide vehicle/tire support. The concept of using internal balls in tires is explained in detail in U.S. Pat. No. 6,896,020 which is incorporated herein by reference.

The wheel assembly 1 includes a wheel rim 4, connected to a central hub 2 and spokes 3. A tire 6 is mounted on the rim 4, defining a hollow space between the tire 6 and the rim 4, and defining an exterior and an interior. Several inflated balls 5 are located in the hollow space between the tire 6 and the rim 4.

As best shown in FIG. 2, the wheel rim 4 has left and right tire bead seating surfaces 7, 8, left and right tire bead retaining flanges 9,10, and a curved central portion 11 defining an internal surface 1 2 and an external surface 1 3. The tire 6 includes embedded steel beads 14A, 14B, sidewalls 15A, 15B, carcass 16, and tread portions 17. The retaining flanges 9, 10 on the rim 4 receive the steel beads 14A, 14B embedded in the tire 6 and seal the tire 6 against the seating surfaces 7, 8 of the rim 4. The tread portions 17 project outwardly from the carcass 16. While the tread portions 17 in this embodiment are knobs, the tread portions 17 may have a variety of known shapes.

The wheel rim 4 defines a plurality of air inlet holes 18 extending from the exterior of the rim 4 to the interior of the rim 4, and the tire 6 defines a plurality of air outlet holes 19 extending from the tire interior to the tire exterior. This creates a plurality of air ventilation paths through the tire assembly by which, as the tire rotates, air flows from the exterior of the rim, through the air inlet holes 18 into the interior of the rim and tire, past the internal balls 5, then through the air outlet holes 19 to the exterior of the tire. The centrifugal force of the rotating tire drives the air through the ventilation paths.

In this embodiment, the inlet holes 18 and outlet holes 19 are located along the lateral centerline of the tire assembly, and the outlet holes 19 extend through the central tread portions 17a of the tire 6.

The openings 22 of the outlet holes 19 formed in the interior surface 20 of the tire 6 are tapered or funnel shaped in order to help minimize the potential blockage of air flow in the event that an internal ball 5 is aligned directly with the opening 22. Although not shown, the interior surface 20 of the tire may also define ridges to support the internal balls and thus provide air channels between the tire inner surface 20 and the outer surfaces of the internal balls 5. Of course, as the tire 6 rotates, there may be momentary blockage of the outlet holes 19 due to the tread portions 17a periodically coming into contact with the terrain surface, as well as due to the elastic deformation of the tread portion 17a. This momentary blockage does not significantly reduce the conduction/convection heat transfer effect of the almost continuous airflow through the ventilation path.

It should be noted that this air flow arrangement requires some type of support for the tire other than that of a typical pneumatic tire. In this case, the support is provided by internal balls. Alternatively, the tire may include an inner tube, or the material of the tire may be stiff enough to provide the support.

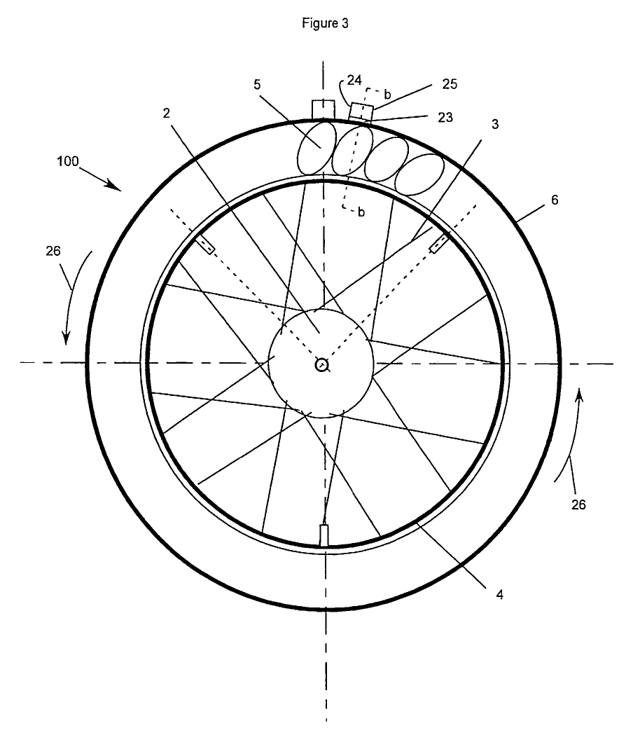

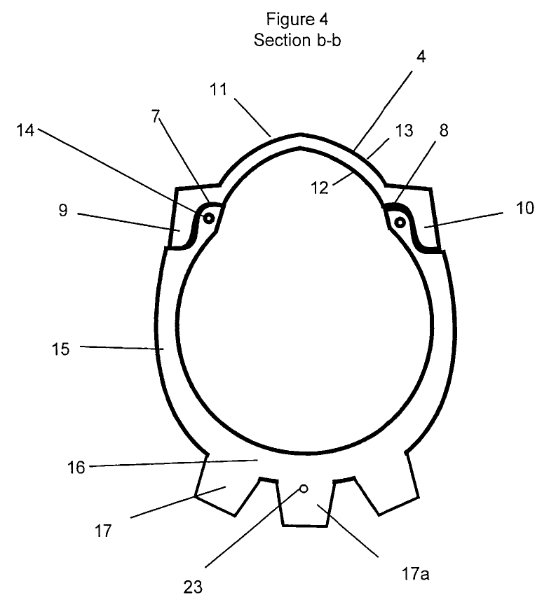

FIGS. 3 and 4 show an alternate embodiment of a tire assembly 100 made in accordance with the present invention. Again, the assembly includes a hub 2, spokes 3, a rim 4, internal balls 5, and a tire 6 with tread portions 17 extending outwardly from the tire carcass 16. However, in this embodiment, instead of holes extending radially through the rim and tire, there are through holes 23 extending through the tread portions 17a in the direction of rotation of the tire 6. In this particular embodiment, the through holes 23 are located at the base of the tread portions 17a, where they connect to the tire carcass 16.

During rotation of the tire in the direction of the arrows 26 shown in FIG. 3, the leading side surface 24 of the tread portion 17a becomes a high pressure area, and the trailing side surface 25 becomes a low pressure area. This pressure differential drives the flow of air through the passageways 23 (from high pressure to low pressure). Obviously, if the tire rotates in the opposite direction, the surface 25 becomes the leading surface, and the air flows in the opposite direction, but, in either case, the passageways 23 are directed in the direction of rotation of the tire.

The passages 23 may be formed using a variety of methods. For example, they may be formed by drilling holes through the tread portions after the tire is manufactured (e.g. with a heated drill bit). In this case, the holes will be straight and are likely to be in a tangential or nearly tangential direction aligned generally in the direction of rotation of the tire. However, more practical methods can be found for incorporating the holes into the manufacture of the tire. For example, a steel cord of the desired diameter may be placed around the tire between the tread rubber layer and the carcass rubber layer. The steel cord would first be coated with high temperature mold release. After the tire molding is complete, the steel cord can be pulled out of the tire, leaving the air passages between the base of the tread portions and the tire carcass. Using this method, the passageways would be curved parallel to the tire carcass, again in the general direction of rotation of the tire. Regardless of the method used to create the passageways, by directing the holes in the general direction of rotation of the tire, a high pressure/low pressure differential is created from one end of the hole to the other when the tire rotates, thereby causing the air to flow along the passageway.

Although this second embodiment describes a tire with ball inflation cells, the air passageways described in this second embodiment can be used on any tire with tread portions, including pneumatic tires, solid tires, and so forth. It is also envisioned that the ventilation configuration described in the first embodiment could be used for non-pneumatic, solid tires such as the “roadwheels” used on military tanks and other track vehicles. In such an instance, there is no hollow space between the rim and tire, and the ventilation holes would extend through the rim and tire only.

It will be obvious to those skilled in the art that modifications may be made to the embodiments described above without departing from the scope of the present invention.

What is claimed is:

1. A tire assembly, comprising:
a rim; and
a tire mounted on said rim, forming a hollow space between said tire and said rim and defining a tire exterior and a tire interior;
wherein said rim defines a plurality of air inlet holes, and said tire defines a plurality of air outlet holes which define air ventilation paths from said exterior through said air inlet holes to said interior and from said interior through said air outlet holes to said exterior.

2. A tire assembly as recited in claim 1, and further comprising a plurality of balls located in said hollow space.

3. A tire assembly as recited in claim 1, wherein said tire includes knobs and said air outlet holes extend through said knobs.

4. A tire assembly as recited in claim 3, wherein said tire is rigid enough to maintain its shape without an internal inflation mechanism.

5. A tire assembly, comprising:
a rim defining an axis of rotation and a direction of rotation;
a tire mounted on said rim, said tire including a plurality of outwardly-projecting tread portions, wherein at least some of said tread portions define through holes extending in the direction of rotation.

6. A tire assembly as recited in claim 5, wherein each of said tread portions defines a base and said through holes are located at the base of their respective tread portions.

7. A tire assembly, comprising:
a tire defining a plurality of air passageways configured such that the rotation of said tire causes air to flow through said passageways.

8. A tire assembly as recited in claim 7, wherein said tire assembly includes a tire and a rim and said air passageways extend through said tire and said rim.

9. A tire assembly as recited in claim 7, wherein said tire assembly defines a direction of rotation;
said tire has an outer surface and a tread projecting outwardly from said outer surface; and
said air passageways extend through said tread in the direction of rotation of said tire.
